(19) United States
(12) Patent Application Publication
(10) Pub. No.: US 2004/0043202 A1
(43) Pub. Date: Mar. 4, 2004

(54) Recording medium

(76) Inventors: Kenichi Kawano, Sakatemachi Mitsukaido-shi (JP); Akira Hashimoto, Mitsukaido-shi (JP); Junko Morioka, Mitsukaido-shi (JP); Hayato Tomihara, Mitsukaido-shi (JP); Ryoji Yashiro, Mitsukaido-shi (JP); Koji Fujimoto, Mitsukaido-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/433,417

(22) PCT Filed: Dec. 3, 2001
(86) PCT No.: PCT/JP01/10550

(30) Foreign Application Priority Data
Dec. 4, 2000 (JP) 2000-368798

(51) Int. Cl. B32B 3/00

(52) U.S. Cl. 428/195.1

(57) ABSTRACT

A recording medium is composed of a base material and an ink-receiving layer arranged on a surface of the base material. The ink-receiving layer comprises an inorganic pigment, a boron compound, and a compound represented by the following formula:

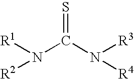

wherein R¹ to R⁴ may be the same or different and each independently represents a hydrogen atom, an alkyl group, an aryl group or a group represented by NR⁵R⁶, R⁵ and R⁶ each independently represents a hydrogen atom, an alkyl group having 1 to 5 carbon atoms, a phenyl group or a group represented by NR⁷CSNR⁸R⁹, R⁷ to R⁹ may be the same or different and each independently represents a hydrogen atom, an alkyl group having 1 to 5 carbon atoms or a phenyl group, and one of R¹ and R² and one of R³ and R⁴ may be fused together to form a ring.

### TECHNICAL FIELD

This invention relates to a recording medium suitable for performing recording with ink, and especially to a recording medium permitting printing of excellent characteristics and reduced in image fading and discoloration by storage over extended time when applied to a printer or plotter making use of ink-jet recording.

### BACKGROUND ART

Ink-jet recording is a recording technique that performs recording of an image, characters or the like by causing tiny droplets of ink to fly in accordance with one of various operation principles and then allowing them to deposit on a recording medium such as paper. Ink-jet recording features high-speed printing performance, low operating noise, applicability for the recording of a wide variety of characters and patterns, easy multi-color printing, and obviation of development and image fixing. In particular, an image formed by multi-color ink-jet recording can provide a record which is no way inferior to an image printed by multi-color printing making use of a form-plate-dependent printing technique or by a color photographic technique. Ink-jet recording has a still further merit in that, when the number of copies or prints to be made is small, ink-jet recording requires lower printing cost than an ordinary printing technique or photographic technique. Ink-jet recording is, therefore, rapidly finding wide-spread utility as image recorders for various information equipment in recent years. For example, ink-jet recording is finding increasing utility in a wide variety of fields in which recording of full-color images is required, for example, output of image designs in design business, production of color block copies in a printing field where the quality of photographic images is required, and production of billboards and catalogs which are frequently updated.

In such ink-jet recording, improvements have been made in recorders and recording methods to improve recording characteristics, for example, to achieve high-speed recording, high-definition recording and full-color recording. Keeping in step with such improvements, an increasing demand has also arisen for recording media of still higher characteristics. Described specifically, characteristics required for recording media include that printed dots can have high density and can produce bright tones; high contrast can be produced; ink absorption property is so high that, even when printed dots overlap, ink does not run off or bleed; spreading or diffusion of ink in horizontal direction does not occur beyond necessity and printed dots have a shape close to a true circle; and dots are smooth along their peripheries and are well defined.

To meet these requirements, certain proposals have been made to date. For example, JP 52-53012 A discloses ink-jet recording paper of the ordinary plain paper type equipped with ink absorption property increased by applying a surface-processing coating formulation as a thin layer to a base paper stock of low sizing. JP 55-51583 A, JP 59-230787 A and JP 64-11877 A each discloses an ink-jet recording medium of the coated type obtained by applying a coating formulation, which comprises a silicon-containing pigment such as silica and a water-based binder, to a base material to improve the shape and density of dots or tone reproducibility in which the above-described ink-jet recording paper of the ordinary plain paper type had been considered to be poor. Further, to obtain surface gloss comparable with that available from silver halide pictures, it has been attempted to apply cast-coating to an ink-receiving layer or to use a superabsorbent polymer in an ink-receiving layer. These attempts are, however, accompanied by drawbacks in that the former cannot provide sufficient gloss and the latter is slower in ink absorption speed than ink-receiving layers formed of fine particles of an inorganic pigment such as silica.

Proposed as recording media increased in ink absorption property, gloss and transparency were recording media each of which had been obtained by applying a fine alumina hydrate together with a water-soluble binder to a base material were proposed. For example, JP 60-232990 A discloses recording paper provided with a coating layer which contains porous cationic alumina hydrate. On the other hand, JP 2-276670 A, JP 6-48016 A, JP 6-55829 A, JP 7-76161 A, JP 8-22608 A, JP 10-44585 A, JP 11-34484 A and JP 2000-239578 A disclose recording sheets containing pseudo-boehmite. In particular, JP 7-76161 A and JP 2000-239578 A disclose recording sheets, each of which contains an alumina sol of the pseudo-boehmite structure and boric acid or a borate salt. In the recording media containing the inorganic pigment, however, recorded images were faded by light, ozone or the like in some instances and under specific conditions, non-printed areas and white backgrounds underwent yellowing.

To avoid these problems, recording media with various antioxidants, ultraviolet absorbers, light stabilizers and/or the like contained therein have been proposed. For example, JP 57-74192 A, JP 57-87989 A and JP 60-72785 A each discloses ink-jet recording paper which contains a phenolic antioxidant and an ultraviolet absorber of the benzophenone or benzotriazole type. JP 61-146591 A proposes a recording medium which contains a hindered amine compound, JP 61-154989 A proposes a recording medium which contains a hydrazide compound, JP 1-18684 A proposes a recording medium which contains an undecane compound, JP 1-115677 A proposes a recording medium which contains a thioether compound, JP 6-286297 A discloses a recording medium which contains a linear polycarboxylic acid, and JP 6-316145 A proposes a recording medium which contains an organic acid having an aromatic nucleus.

Further, JP 4-34953 B and JP 7-314883 A each discloses a recording medium containing a thiourea derivative, a thiosemicarbazide derivative, a thiocarbohydrazide derivative or the like. On the other hand, JP 8-25796 A discloses a recording medium which contains one of a thiourea derivative, a thiosemicarbazide derivative and a thiocarbohydrazide derivative and one of iodine, an iodine compound, a dithiocarbamic acid, a thiocyanate salt and a thiocyanate ester. It is, however, the current circumstances that no sufficient effect has been obtained yet from such conventional approaches.

With the foregoing current circumstances in view, the present invention has as an object the provision of a recording medium which provides high image density, exhibits good tone and ink absorption property, and is reduced in image fading and discoloration by storage over extended time.

### DISCLOSURE OF THE INVENTION

The present inventors have proceeded with various investigations to obtain a recording medium permitting printing of excellent quality and reduced in image fading and discoloration by storage over extended time. As a result, it has been found that in a recording medium having an ink-receiving layer composed of an inorganic pigment and a water-soluble resin as principal components, incorporation of a compound represented by the below-described formula (1) and a boron compound in the ink-receiving layer makes it possible to achieve the above-described object, leading to completion of the present invention.

The present invention, therefore, provides a recording medium composed of a base material and an ink-receiving layer arranged on a surface of said base material, characterized in that the ink-receiving layer comprises an inorganic pigment, a boron compound, and a compound represented by the following formula (1), wherein said compound represented by the formula (1) and said boron compound are contained at a weight ratio in a range of from 0.01:60 to 10:0.01:

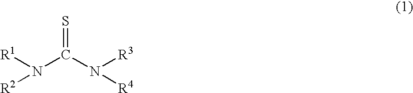

wherein R¹ to R⁴ may be the same or different and each independently represents a hydrogen atom, an alkyl group, an aryl group or a group represented by —NR⁵R⁶, R¹ and R⁶ each independently represents a hydrogen atom, an alkyl group having 1 to 5 carbon atoms, a phenyl group or a group represented by —NR⁷CSNR⁸R⁹, R⁷ to R⁹ may be the same or different and each independently represents a hydrogen atom, an alkyl group having 1 to 5 carbon atoms or a phenyl group, and one of R¹ and R² and one of R³ and R⁴ may be fused together to form a ring.

The inorganic pigment may preferably be at least one of silica, alumina, an alumina hydrate of the boehmite structure and an alumina hydrate of the pseudo-boehmite structure. More preferably, the inorganic pigment may be at least one of silica, alumina, an alumina hydrate of the boehmite structure and an alumina hydrate of the pseudo-boehmite structure, each of which has a BET surface area of at least 100 m²/g. The compound represented by the formula (1) may preferably be contained in a proportion of from 0.01 to 10 parts by weight per 100 parts by weight of said inorganic pigment. The boron compound may preferably be a boric acid or a borate salt. The boron compound may preferably be contained in a proportion of from 0.01 to 60 parts by weight per 100 parts by weight of the inorganic pigment.

Owing to the arrangement of the above-described ink-receiving layer, the recording medium according to the present invention permits printing of excellent characteristics, that is, formation of images excellent density and tone while exhibiting superb ink absorption property and is reduced in image fading and discoloration by storage over extended time.

### BEST MODES FOR CARRYING OUT THE INVENTION

The present invention will hereinafter be described in more specifically based on certain preferred embodiments.

No particular limitation is imposed on the base material for use in the present invention. Examples can include base materials composed of paper or the like, such as adequately sized paper, non-sized paper, coated paper, and resin-coated paper making use of polyethylene or the like; transparent films of thermoplastic resins such as polyethylene, polyesters, polystyrene, polyacetates, polyvinyl chloride, cellulose acetate, polyethylene terephthalate, polymethyl methacrylate and polycarbonates; sheet-like materials (synthetic paper and the like) formed of films opacified by inorganic fillers or fine bubbles; and sheets made of fabric, glass or metals. To improve the adhesion strength between these base materials and the ink-receiving layer, corona discharge treatment or various undercoating treatments can be applied to surfaces of these base materials.

The inorganic pigment for use in the present invention may preferably be fine inorganic particles, which have high ink-absorbing ability and excellent color producibility and permit formation of images of high quality. Illustrative of such fine inorganic particles are calcium carbonate, magnesium carbonate, kaolin, clay, talc, calcium sulfate, barium sulfate, titanium dioxide, zinc carbonate, zinc sulfide, zinc oxide, zinc hydroxide, hydrotalcite, aluminum silicate, calcium silicate, magnesium silicate, diatomaceous earth, alumina, colloidal alumina, aluminum hydroxide, alumina hydrates of the boehmite structure, alumina hydrates of the pseudo-boehmite structure, synthetic amorphous silica, colloidal silica, lithopone, zeolite, and magnesium hydroxide. These materials can be used either singly or in combination.

The present invention is characterized in that an ink-receiving layer is formed by using the compound represented by the formula (1) and the boron compound together with the pigment. In the compound represented by the formula (1), R¹ to R⁹ have the same meanings as defined above. When R¹ to R⁴ are alkyl groups, those having 1 to 10 carbon atoms are preferred. When R¹ to R⁴ are aryl groups, phenyl groups or naphthyl groups are preferred. These alkyl and aryl groups may each be unsubstituted or substituted.

Specific examples of the compound represented by the formula (1) can include those to be described hereinafter. Firstly, illustrative of the compound represented by the formula (1) in which R¹ to R⁴ each represents a hydrogen atom, an alkyl group or an aryl group are:

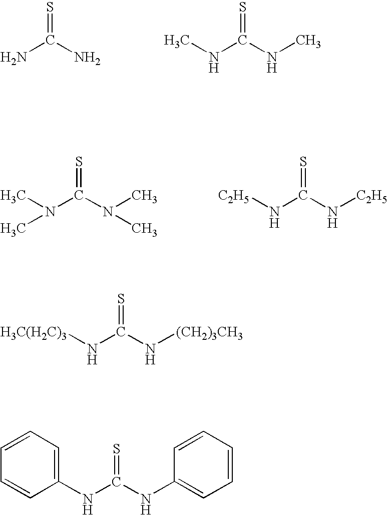

Illustrative of the compound represented by the formula (1) in which at least one of R¹ to R⁴ is a group represented by —NR⁵R⁶ are:

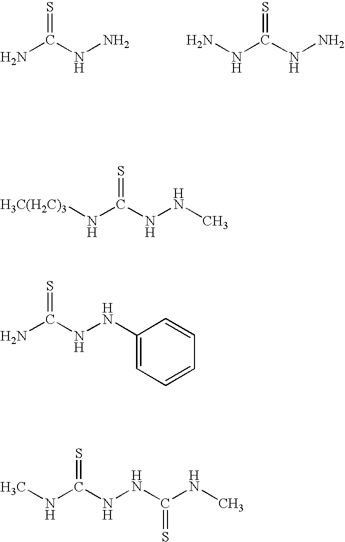

Illustrative of the compound represented by the formula (1) in which one of R¹ and R² and one of R³ and R⁴ may be fused together to form a ring are:

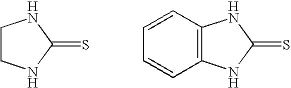

From the viewpoint of ink absorption property and image fading and discoloration preventing effects, the compound represented by the formula (1) may be contained in a proportion of from 0.01 to 10 parts by weight per 100 parts by weight of the inorganic pigment. The more preferred range is from 0.1 to 10 parts by weight per 100 parts by weight of the inorganic pigment. In this more preferred range, ink bleeding and beading can be prevented still more effectively.

In the present invention, the boron compound is used along with the compound represented by the formula (1). The boron compound for use in the present invention may preferably be an oxyacid formed around a boron atom as a center or a salt thereof, such as boric acid or a borate salt. Specific examples can include orthoboric acid, metaboric acid, hypoboric acid, tetraboric acid and pentaboric acid, and salts thereof.

Boric acid is commonly used as a hardener for improving the film-forming properties, waterproofness and film strength of films formed of hydrophilic polymers. Depending upon the types of reactive groups contained in polymers to be used, various hardeners are chosen, respectively. In the case of a polyvinyl alcohol resin, for example, an epoxy hardener or an inorganic hardener such as boric acid or a water-soluble aluminum salt is used. However, the role of the boron compound in the present invention is to increase the fading preventing effect or the discoloration preventing effect for images when incorporated especially along with the compound represented by the formula (1) in the recording medium, and therefore, is different from that of the same compound in the application where its utility is limited to the effect as a hardener.

The content of the boron compound varies considerably depending upon the content of the inorganic pigment and that of a water-soluble resin which may be used as a binder. Preferably, however, the boron compound may be contained in a proportion of from 0.01 to 60 parts by weight per 100 parts by weight of the inorganic pigment within such a range that the compound represented by the formula (1) and the boron compound are contained at a weight ratio of from of 0.01:60 to 10:0.01. More preferably, the boron compound may be contained in a proportion of from 0.1 to 20 parts by weight per 100 parts by weight of the inorganic pigment within such a range that the compound represented by the formula (1) and the boron compound are contained at a weight ratio of from of 0.1:20 to 10:0.1. If the content of the boron compound is lower than 0.01 part by weight per 100 parts by weight of the inorganic pigment, the advantageous effects of the present invention cannot be fully brought about so that the image fading and discoloration preventing effects may not be exhibited sufficiently. If its content conversely exceeds 60 parts by weight, the viscosity of a coating formulation used to form an ink-receiving layer will undergo substantial variations with time, possibly leading to a reduction in the stability of coating work.

The recording medium according to the present invention can be obtained by preparing a coating formulation of the above-described components and then applying the coating formulation to a surface of a base material to form an ink-receiving layer. This ink-receiving layer may preferably include voids, which are formed by the inorganic pigment and a small amount of a water-soluble resin. For the availability of smaller voids, use of silica, alumina, an alumina hydrate of the boehmite structure or an alumina hydrate of the pseudo-boehmite structure as the inorganic pigment is preferred. Particularly preferred is silica, alumina, an alumina hydrate of the boehmite structure or an alumina hydrate of the pseudo-boehmite structure, the BET specific surface area of which is at least 100 m²/g.

An alumina hydrate usable in the present invention can be represented by the following formula (2):

Al₂O₃.nH₂O (2)

Depending upon the value for which n stands, the alumina hydrate can be classified generally into one of different crystalline forms such as the boehmite structure, the pseudo-boehmite structure and the amorphous structure. Alumina hydrates suitable for use in the present invention, however, are those represented by the formula (2) in which n ranges from 1 to 3.

The recording medium according to the present invention can be obtained by mixing a composition, which comprises the inorganic pigment, the compound represented by the formula (1) and the boron compound, with a water-soluble resin and an aqueous medium in amounts as much as needed into a coating formulation, applying the coating formulation to a surface of a base material and then drying the thus-applied coating formulation into an ink-receiving layer.

As the construction of the recording medium according to the present invention, it is possible to choose a construction with an ink-receiving layer arranged on a base material like coated paper or coated film; a construction with an ink-receiving layer formed by impregnating a base material with a portion or a major portion of a coating formulation in the vicinity of a surface of the base material; or a construction with an ink-receiving layer formed by applying a small amount of a coating formulation to a surface of a base material. In the present invention, these constructions shall all be embraced by the expression that “an ink-receiving layer is formed on a surface of a base material”.

The water-soluble resin which is included in the coating formulation can be a water-soluble or water-dispersible high molecular compound. Illustrative are starch, gelatin and casein, and modified products thereof; cellulose derivatives such as methylcellulose, carboxymethylcellulose and hydroxyethylcellulose; completely or partially saponified polyvinyl alcohols are modified products thereof (including those modified with cations, anions, silanols or the like); urea resins; melamine resins; epoxy resins; epichlorohydrin resins; polyurethane resins; polyethylene-imine resins; polyamide resins; polyvinyl pyrrolidone resins; polyvinyl butyral resins; poly(meth)acrylic acid and copolymers thereof; acrylamide resins; maleic anhydride copolymers; polyester resins; SBR latex; NBR latex; methyl methacrylate-butadiene copolymer latex; acrylic polymer latexes such as acrylate ester copolymers; vinyl polymer latexes such as ethylene-vinyl acetate copolymer; and functional-group-modified polymer latexes formed by bonding cationic groups or anionic groups to a variety of these polymer latexes. Preferred is polyvinyl alcohol obtained by hydrolyzing polyvinyl acetate and having an average polymerization degree of from 300 to 5,000. Its saponification degree may preferably be from 70 to lower than 100%, with 80 to 99.5% being particularly preferred. These water-soluble or water-dispersible resins can be used either singly or in combination.

No particular limitation is imposed on the aqueous medium which will act as a base material in the coating formulation, insofar as it is water or a mixture of water and a water-miscible organic solvent. Examples of the water-miscible organic solvent can include alcohols such as methanol, ethanol and propanol; lower alkyl ethers of polyhydric alcohols, ethylene glycol monomethyl ether and ethylene glycol dimethyl ether; ketones such as acetone and methyl ethyl ketone; and ethers such as tetrahydrofuran.

No particular limitation is imposed on the concentration of solids in the coating formulation adapted to form an ink-receiving layer, insofar as the coating formulation has a viscosity sufficient to form the ink-receiving layer on the base material. The preferred solid concentration may, however, range from 5 to 50% by weight based on the whole weight of the coating formulation. A solid concentration lower than 5 wt. % leads to a need for increasing the coat weight to form an ink-receiving layer of sufficient thickness. As longer time and greater energy are required for drying, such a low solid concentration may not be economical in some instances. A solid concentration higher than 50 wt.%, on the other hand, results in a coating formulation of high viscosity, and the coatability may be reduced in some instances.

The mixing weight ratio of the inorganic pigment to the water-soluble resin in the coating formulation may preferably be in a range of from 1:1 to 30:1, with a range of from 1:1 to 25:1 being more preferred. Setting of the proportion of the water-soluble resin within this range makes it possible to provide the resulting ink-receiving layer with resistance to crazing or separation as dust and also with good ink absorption property.

To apply such a coating formulation to a base material, a conventionally-known coating method can be used, such as spin coating, roll coating, blade coating, air knife coating, gate roll coating, bar coating, size pressing, spray coating, gravure coating, curtain coating, rod blade coating, lip coating, or slit die coating. Subsequent to the coating, the surface smoothness of the ink-receiving layer can be improved by calender roll or the like as needed.

As a coat weight of the coating formulation to the base material, the preferred range is from 0.5 to 50 g/m², and the more preferred range is from 1.0 to 45 g/m². A coat weight smaller than 0.5 g/m² may result in formation of an ink-receiving layer incapable of absorbing water sufficiently so that ink may run off or an image may bleed. A coat weight greater than 50 g/m², on the other hand, leads to occurrence of curling upon drying so that concerning printing performance, advantageous effects may not be brought about to such marked extent as expected.

The compound represented by the formula (1) can be used by adding it directly to a coating formulation as described above or by adding it to a recording medium on which an ink-receiving layer has been formed with the inorganic pigment and other component(s). When the compound represented by the formula (1) is used by the latter method, it can be added by dissolving or dispersing it in a solvent beforehand and immersing the recording medium in the solution or overcoating the solution to the recording medium.

The recording medium according to the present invention can be obtained by applying the coating formulation to the base material by one of these coating methods and drying the thus-applied coating formulation in a drier such as a hot air drier, hot drum or far-infrared drier. The base material can be provided on one side thereof with an ink-receiving layer or on both sides thereof with ink-receiving layers, respectively. When ink-receiving layers are applied to both sides, respectively, these ink-receiving layers may have the same composition or different compositions.

To the ink-receiving layer of the recording medium according to the present invention, other materials can be added to extents not impairing its performance as an ink-recording medium. Examples of such other materials can include mordant dyes, mordant pigments, dye fixing agents, dispersants, thickeners, pH controllers, lubricants, flow modifiers, surfactants, antistatic agents, defoamers, foam inhibitors, parting agents, penetrants, fluorescent whitening agents, ultraviolet absorbers, and antioxidants.

Although it is not clear why the recording medium of the present invention as described above permits printing of excellent quality and especially exhibits superb effects for the inhibition of fading and discoloration of images by storage over extended time, certain interaction appears to take place between the compound represented by the formula (1) and the boron compound to develop such effects.

No particular limitation is imposed on ink to be used upon making a record on the recording medium according to the present invention. It is, however, preferred to use general water-base ink for ink-jet recording, in which a dye or pigment is used as a colorant, a mixture of water and a water-miscible organic solvent is used as a medium, and the dye or pigment is dissolved or dispersed in the medium.

### EXAMPLES

The present invention will hereinafter be described specifically based on Examples, in which each designation of “part” or “parts” or “%” is on a weight basis unless otherwise specifically indicated.

Ranking of the fading and discoloration inhibiting effects of each recording medium in the present invention was conducted by the following method.

<Ranking Method of Fading and Discoloration Inhibiting Effects>

On each recording medium, solid printing was performed with single-color inks of black (BK) and cyan (C) by using an ink-jet recording machine (“BJF850”, trade name; manufactured by Canon Kabushiki Kaisha). By ozone exposure testing equipment (manufactured by SUGA TEST INSTRUMENTS Co., LTD.), the recorded medium was exposed to 3 ppm ozone for 2 hours at 40° C. and 55% RH. A color difference (ΔE) of a printed area between before and after the exposure to ozone was next measured using a calorimeter (“ZE-2000”, trade name; manufactured by Nippon Denshoku Industries Co., Ltd.).

### Example 1

A dispersion of silica (10 parts; “Fine Seal X-60”, trade name, product of TOKUYAMA CORPORATION; BET specific surface area: 290 m²/g;) in water (44.3 parts) and a solution of polyvinyl alcohol (5 parts; “PVA-224”, trade name, product of Kuraray Co., Ltd.) in water (45 parts) were mixed. Thiourea (0.3 part, 3% based on the silica) and a 3% aqueous solution of boric acid (0.2 part in terms of solid, 2% based on the silica) were added to the mixture to prepare a coating formulation. Using resin-coated paper as a base material, the above-prepared coating formulation was applied to the base material by the bar coating method to give a dry coat weight of 20 g/m². The thus-coated base material was then dried in hot air at 110° C. for 15 minutes to form an ink-receiving layer. Using the thus-obtained recording medium, a ranking test was conducted as described above. The results are presented in Table 1.

### Example 2

A recording medium was prepared in a similar manner as in Example 1 except that the amount of the 3% aqueous solution of boric acid was changed to 0.6 part in terms of solid (6% based on the silica), and a ranking test was conducted by exposure to ozone as described above. The results are presented in Table 1.

### Comparative Example 1

A recording medium was prepared in a similar manner as in Example 1 except that neither thiourea nor the 3% aqueous solution of boric acid were added, and a ranking test was conducted as described above. The results are presented in Table 1.

### Comparative Example 2

A recording medium was prepared in a similar manner as in Example 1 except that thiourea was not added, and a ranking test was conducted as described above. The results are presented in Table 1.

### Comparative Example 3

A recording medium was prepared in a similar manner as in Example 1 except that the 3% aqueous solution of boric acid was not added, and a ranking test was conducted as described above. The results are presented in Table 1.

### Example 3

A commercial alumina hydrate dispersion [100 parts; “Cataloid AS-3”, trade name, product of Catalysts & Chemicals Industries Co., Ltd.; solid concentration: 9% (as measured after dried at 150° C. for 1 hour)] and a solution of polyvinyl alcohol (0.9 part; “PVA-224”, trade name, product of Kuraray Co., Ltd.) in water (8.1 parts) were mixed. Thiourea (0.27 part, 3% based on the alumina hydrate) and a 3% aqueous solution of boric acid (0.18 part in terms of solid, 2% based on the alumina hydrate) were added to the mixture to prepare a coating formulation. Using resin-coated paper as a base material, the above-prepared coating formulation was applied to the base material by the bar coating method to give a dry coat weight of 20 g/m². The thus-coated base material was then dried in hot air at 60° C. for 1 hour to form an ink-receiving layer. Using the thus-obtained recording medium, a ranking test was conducted as described above. The results are presented in Table 1.

Incidentally, the alumina hydrate dispersion employed in this Example was dried at room temperature, and an X-ray diffraction pattern of the resultant solid was measured. The alumina hydrate was found to have the pseudo-boehmite structure. Further, its BET specific surface area by the nitrogen absorption/desorption analysis was 263 m²/g.

### Example 4

A recording medium was prepared in a similar manner as in Example 3 except that the amount of the 3% aqueous solution of boric acid was changed to 0.54 part in terms of solid (6% based on the alumina hydrate), and a ranking test was conducted as described above. The results are presented in Table 1.

### Example 5

A recording medium was prepared in a similar manner as in Example 3 except that the amount of the 3% aqueous solution of boric acid was changed to 0.72 part in terms of solid (8% based on the alumina hydrate), and a ranking test was conducted as described above. The results are presented in Table 1.

### Example 6

A recording medium was prepared in a similar manner as in Example 3 except that thiosemicarbazide (0.65 part, 7.22% based on the alumina hydrate) was added in place of thiourea, and a ranking test was conducted as described above. The results are presented in Table 1.

### Example 7

A recording medium was prepared in a similar manner as in Example 3 except that 1,3-dimethylthiourea (0.374 parts 4.15% based on the alumina hydrate) was added in place of thiourea, and a ranking test was conducted as described above. The results are presented in Table 1.

### Example 8

The same alumina hydrate dispersion as that employed in Example 3 (100 parts) and a solution of polyvinyl alcohol (0.9 part; “PVA-224”, trade name, product of Kuraray Co., Ltd.) in water (8.1 parts) were mixed. A 3% aqueous solution of boric acid (0.54 part in terms of solid, 6% based on the alumina hydrate) was added to the mixture to prepare a coating formulation. Using resin-coated paper as a base material, the above-prepared coating formulation was applied to the base material by the bar coating method to give a dry coat weight of 18.66 g/m². The thus-coated base material was then dried in hot air at 60° C. for 1 hour to form an ink-receiving layer. Further, 1,3-dimethylthiourea (1 part) was dissolved in ethanol (40 parts), the resulting solution was coated to the above-prepared ink-receiving layer by the bar coating method to give a dry coat weight of 1.34 g/m² (8.3% based on the alumina hydrate in the ink-receiving layer), and the thus-coated base material was then dried in hot air at 100° C. for 5 minutes to prepare a recording medium. Using the thus-obtained recording medium, a ranking test was conducted as described above. The results are presented in Table 1.

### Example 9

In a similar manner as in Example 8, a coating formulation composed of alumina hydrate, polyvinyl alcohol and boric acid was prepared, and an ink-receiving layer of a dry coat weight of 18.48 g/m² was formed on resin-coated paper. Next, 1,3-diphenylthiourea (1 part) was dissolved in tetrahydrofuran (40 parts; hereinafter abbreviated as “THF”), the resulting solution was coated to the above-prepared ink-receiving layer by the bar coating method to give a dry coat weight of 1.52 g/m² (9.51% based on the alumina hydrate in the ink-receiving layer), and the thus-coated base material was then dried in hot air at 100° C. for 5 minutes to form a recording medium. Using the thus-obtained recording medium, a ranking test was conducted as described above. The results are presented in Table 1.

### Example 10

A coating formulation composed of alumina hydrate, polyvinyl alcohol and boric acid was prepared in a similar manner as in Example 8 except that the amount of the 3% aqueous solution of boric acid was changed to 0.18 part (2% based on the alumina hydrate), and an ink-receiving layer of a dry coat weight of 19.48 g/m² was formed on resin-coated paper. Next, N,N′-orthophenylenethiourea (1 part) was dissolved in THF (40 parts), the resulting solution was coated to the above-prepared ink-receiving layer by the bar coating method to give a dry coat weight of 0.52 g/m² (3% based on the alumina hydrate in the ink-receiving layer), and the thus-coated base material was then dried in hot air at 100° C. for 5 minutes to form a recording medium. Using the thus-obtained recording medium, a ranking test was conducted as described above. The results are presented in Table 1.

### Comparative Example 4

A recording medium was prepared in a similar manner as in Example 3 except that neither thiourea nor the 3% aqueous solution of boric acid were added, and a ranking test was conducted as described above. The results are presented in Table 1.

### Comparative Example 5

A recording medium was prepared in a similar manner as in Example 3 except that thiourea was not added, and a ranking test was conducted as described above. The results are presented in Table 1.

### Comparative Example 6

A recording medium was prepared in a similar manner as in Example 4 except that thiourea was not added, and a ranking test was conducted as described above. The results are presented in Table 1.

### Comparative Example 7

A recording medium was prepared in a similar manner as in Example 3 except that the 3% aqueous solution of boric acid was not added, and a ranking test was conducted as described above. The results are presented in Table 1.

### Comparative Example 8

A recording medium was prepared in a similar manner as in Example 6 except that the 3% aqueous solution of boric acid was not added, and a ranking test was conducted as described above. The results are presented in Table 1.

### Comparative Example 9

A recording medium was prepared in a similar manner as in Example 7 except that the 3% aqueous solution of boric acid was not added, and a ranking test was conducted as described above. The results are presented in Table 1.

### Comparative Example 10

A coating formulation was prepared in a similar manner as in Example 8 except that the 3% aqueous solution of boric acid was not added, and an ink-receiving layer of a dry coat weight of 18.6 g/m² was formed on resin-coated paper. Next, 1,3-dimethylthiourea (1 part) was dissolved in ethanol (40 parts), the resulting solution was coated to the above-prepared ink-receiving layer by the bar coating mehod to give a dry coat weight of 1.4 g/m² (8.3% based on the alumina hydrate in the ink-receiving layer), and the thus-coated base material was then dried in hot air at 100° C. for 5 minutes to form a recording medium. Using the thus-obtained recording medium, a ranking test was conducted as described above. The results are presented in Table 1.

### Comparative Example 11

A coating formulation was prepared in a similar manner as in Example 8 except that the 3% aqueous solution of boric acid was not added, and an ink-receiving layer of a dry coat weight of 18.41 g/m² was formed on resin-coated paper. Next, 1,3-diphenylthiourea (1 part) was dissolved in THF (40 parts), the resulting solution was coated to the above-prepared ink-receiving layer by the bar coating method to give a dry coat weight of 1.59 g/m² (9.51% based on the alumina hydrate in the ink-receiving layer), and the thus-coated base material was then dried in hot air at 100° C. for 5 minutes to form a recording medium. Using the thus-obtained recording medium, a ranking test was conducted as described above. The results are presented in Table 1.

### Comparative Example 12

A coating formulation was prepared in a similar manner as in Example 8 except that the 3% aqueous solution of boric acid was not added, and an ink-receiving layer of a dry coat weight of 19.47 g/m² was formed on resin-coated paper. Next, N,N′-orthophenylenethiourea (1 part) was dissolved in THF (40 parts), the resulting solution was coated to the above-prepared ink-receiving layer by the bar coating method to give a dry coat weight of 0.53 g/m² (3% based on the alumina hydrate in the ink-receiving layer), and the thus-coated base material was then dried in hot air at 100° C. for 5 minutes to form a recording medium. Using the thus-obtained recording medium, a ranking test was conducted as described above. The results are presented in Table 1.

TABLE 1

| | | Amount of | | | | | |
|---|---|---|---|---|---|---|---|
| | | added boric | Compound of formula (1) | | | | |
| | | acid (% | | | | Color | |
| | | based on | | (% based on | | difference | |
| | | inorganic | | inorganic | Manner of | (ΔE) | |
| | Pigment | pigment) | Compund name | pigment) | addition | BK | C |
| Example 1 | Silica | 2 | Thiourea | 3 | Added | 14 | 13 |
| Example 2 | | 6 | Thiourea | 3 | Added | 4 | 5 |
| Comp. Ex. 1 | | — | — | — | — | 27 | 24 |
| Comp. Ex. 2 | | 2 | — | — | — | 24 | 21 |
| Comp. Ex. 3 | | — | Thiourea | 3 | Added | 22 | 17 |
| Example 3 | Alumina | 2 | Thiourea | 3 | Added | 31 | 14 |
| Example 4 | hydrate | 6 | Thiourea | 3 | Added | 24 | 10 |
| Example 5 | | 8 | Thiourea | 3 | Added | 20 | 9 |
| Example 6 | | 2 | Thiosemicarbazide | 7.22 | Added | 17 | 8 |
| Example 7 | | 2 | 1,3-Dimethylthiourea | 4.15 | Added | 31 | 4 |
| Example 8 | | 6 | 1,3-Dimethylthiourea | 8.3 | Overcoated | 36 | 19 |
| Example 9 | | 6 | 1,3-Diphenylthiourea | 9.51 | Overcoated | 24 | 24 |
| Example 10 | | 2 | 2-Benzimidazolethiol | 3 | Overcoated | 42 | 24 |
| Comp. Ex. 4 | | — | — | — | — | 54 | 25 |
| Comp. Ex. 5 | | 2 | — | — | — | 62 | 28 |
| Comp. Ex. 6 | | 6 | — | — | — | 51 | 32 |
| Comp. Ex. 7 | | — | Thiourea | 3 | Added | 36 | 15 |
| Comp. Ex. 8 | | — | Thiosemicarbazide | 7.22 | Added | 25 | 15 |
| Comp. Ex. 9 | | — | 1,3-Dimethylthiourea | 4.15 | Added | 40 | 14 |
| Comp. Ex. 10 | | — | 1,3-Dimethylthiourea | 8.3 | Overcoated | 43 | 21 |
| Comp. Ex. 11 | | — | 1,3-Diphenylthiourea | 9.51 | Overcoated | 40 | 29 |
| Comp. Ex. 12 | | — | 2-Benzimidazolethiol | 3 | Overcoated | 44 | 27 |

The expression “image fading and discoloration by storage over extended time” as used herein means color variations of a printed image in a room into which no direct sunlight enters. Concerning coated paper, fading of an image by ozone is generally considered to be one of indexes indicative of fading by a cause other than light. It is therefore considered that the lower the color difference (ΔE), the more inhibited the fading or discoloration by storage over extended time.

As is evident from the foregoing Examples and Comparative Examples, the recording media according to the present invention in each of which the compound represented by the formula (1) and the boron compound were added to the ink-receiving layer were better in fading resistance than the recording media each of which was added with only the compound represented by the formula (1) or the boron compound or contained neither compounds. In addition, the recording media according to the present invention all permitted printing of excellent characteristics.

Industrial Applicability

Owing to the incorporation of the compound represented by the formula (1) and the boron compound in the ink-receiving layer, the recording medium according to the present invention can print images of excellent quality and can reduce fading and discoloration of the images by storage over extended time. The recording medium is useful especially for ink-jet recording.

1. (Amended) A recording medium composed of a base material and an ink-receiving layer arranged on a surface of said base material, characterized in that said ink-receiving layer comprises an inorganic pigment, a boron compound, and a compound represented by the following formula (1), wherein said compound represented by the formula (1) and said boron compound are contained at a weight ratio in a range of from of 0.01:60 to 10:0.01: 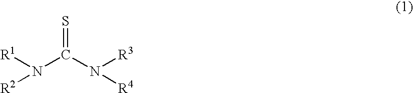
wherein R¹ to R⁴ may be the same or different and each independently represents a hydrogen atom, an alkyl group, an aryl group or a group represented by —NR⁵R⁶, R⁵ and R⁶ each independently represents a hydrogen atom, an alkyl group having 1 to 5 carbon atoms, a phenyl group or a group represented by —NR⁷CSNR⁸R⁹, R⁷to R⁹ may be the same or different and each independently represents a hydrogen atom, an alkyl group having 1 to 5 carbon atoms or a phenyl group, and one of R¹ and R² and one of R³ and R⁴ may be fused together to form a ring.

2. A recording medium according to claim 1, wherein said inorganic pigment is at least one of silica, alumina, an alumina hydrate of the boehmite structure and an alumina hydrate of the pseudo-boehmite structure.

3. A recording medium according to claim 1, wherein said inorganic pigment is at least one of silica, alumina, an alumina hydrate of the boehmite structure and an alumina hydrate of the pseudo-boehmite structure, each of which has a BET surface area of at least 100 m²/g.

4. A recording medium according to claim 1, wherein said compound represented by the formula (1) is contained in a proportion of from 0.01 to 10 parts by weight per 100 parts by weight of said inorganic pigment.

5. A recording medium according to claim 1, wherein said boron compound is a boric acid or a borate salt.

6. (Amended) A recording medium according to claim 1, wherein said boron compound is contained in a proportion of from 0.01 to 60 parts by weight per 100 parts by weight of said inorganic pigment.
